(19) United States
(12) Patent Application Publication
(10) Pub. No.: US 2025/0096299 A1
(43) Pub. Date: Mar. 20, 2025

(54) CELL ASSEMBLY MANUFACTURING DEVICE AND CELL ASSEMBLY MANUFACTURING METHOD

(71) Applicant: SK On Co., Ltd., Seoul (KR)

(72) Inventors: Jeong Been KIM, Daejeon (KR); Yun U CHANG, Daejeon (KR); Yong Hun JUNG, Daejeon (KR); Jun Yong CHOI, Daejeon (KR)

(21) Appl. No.: 18/793,942

(22) Filed: Aug. 5, 2024

(30) Foreign Application Priority Data
Sep. 19, 2023 (KR) 10-2023-0124632

(51) Int. Cl. H01M 10/04; H01M 50/105; H01M 50/143

(52) U.S. Cl. CPC H01M 10/0404; H01M 50/105; H01M 50/143

(57) ABSTRACT

A cell assembly manufacturing device includes an alignment unit including a guide jig configured to align a position of a battery cell; an attachment unit configured to attach a flame spread prevention sheet to the battery cell; a sensor module configured to sense a position of the guide jig and a position of the flame spread prevention sheet; and a processor configured to inspect an attachment position of the flame spread prevention sheet, based on the position of the guide jig and the position of the flame spread prevention sheet sensed by the sensor module.

### CROSS-REFERENCE TO RELATED APPLICATION(S)

This application claims benefit of priority to Korean Patent Application No. 10-2023-0124632 filed on Sep. 19, 2023 in the Korean Intellectual Property Office, the disclosure of which is incorporated herein by reference in its entirety.

### TECHNICAL FIELD

The disclosure and implementations disclosed in this patent document generally relate to a cell assembly manufacturing device and a cell assembly manufacturing method. More specifically, the disclosure of this patent document relates to a cell assembly manufacturing device capable of inspecting an attachment position of a flame spread prevention sheet, and a cell assembly manufacturing method capable of inspecting an attachment position of a flame spread prevention sheet.

### BACKGROUND

Unlike primary batteries, secondary batteries may be charged and discharged, and may thus be applied to devices within various fields such as digital cameras, mobile phones, laptops, hybrid vehicles, electric vehicles, and energy storage systems (ESS). The secondary battery may be a lithium ion battery, a nickel-cadmium battery, a nickel-metal hydride battery, or a nickel-hydrogen battery.

Secondary batteries may be manufactured as flexible pouch-type battery cells or rigid prismatic or cylindrical can-type battery cells. A plurality of battery cells may be formed as a stacked cell assembly.

A cell assembly may be disposed in a case to form a battery module, and a plurality of battery modules may be disposed in a pack frame to form a battery pack. The battery pack may be used in various structures such as a vehicle or an energy storage system.

### SUMMARY

A flame spread prevention sheet may be used to prevent transfer of flames or gas generated by a battery cell and to delay thermal runaway. For example, a flame spread prevention sheet may be attached to at least a portion of a plurality of battery cells. After the flame spread prevention sheet is attached to the battery cell, when an attachment position of the flame spread prevention sheet is inspected, a portion of the flame spread prevention sheet may not be visible, which may reduce attachment and inspection accuracy of the flame spread prevention sheet. When the flame spread prevention sheet is not attached in a correct position, flames may spread between the battery cells.

According to an aspect of the disclosure of this patent document, a cell assembly manufacturing device and a cell assembly manufacturing method with increased attachment accuracy of a flame spread prevention sheet may be provided.

According to an aspect of the disclosure of this patent document, a cell assembly manufacturing device and a cell assembly manufacturing method with increased inspection accuracy for determining an attachment position of a flame spread prevention sheet may be provided.

Battery devices (e.g., battery modules or battery packs) manufactured by a cell assembly manufacturing device or a cell assembly manufacturing method of the disclosure of this patent document may be widely applied to devices within green technology fields such as electric vehicles, battery charging stations, and devices within other fields, such as solar power generation and wind power generation devices using batteries, or the like. In addition, battery devices manufactured by a cell assembly manufacturing device or a cell assembly manufacturing method of the disclosure of this patent document may suppress the emission of air pollution and greenhouse gases, to be used in eco-friendly electric vehicles, hybrid vehicles, or the like, for ameliorating the effects of climate change.

According to an aspect of the disclosure of this patent document, a cell assembly manufacturing device of the disclosure of this patent document may include an alignment unit including a guide jig configured to align a position of a battery cell; an attachment unit configured to attach a flame spread prevention sheet to the battery cell; a sensor module configured to sense a position of the battery cell, a position of the guide jig, and a position of the flame spread prevention sheet; and a processor configured to inspect an attachment position of the flame spread prevention sheet, based on the position of the guide jig and the position of the flame spread prevention sheet sensed by the sensor module.

According to an embodiment, the cell assembly manufacturing device may further include a memory configured to store information reflecting a first distance between a first point of the guide jig and a second point of the battery cell. The processor may be configured to determine a second distance between the first point and an edge of the flame spread prevention sheet, based on information sensed by the sensor module. The processor may be configured to inspect the attachment position of the flame spread prevention sheet, based on a difference between the first distance and the second distance.

According to an embodiment, the flame spread prevention sheet may include a first surface and a second surface protruding from a portion of the first surface. The processor may be configured to inspect the attachment position of the flame spread prevention sheet, based on a difference between the first distance and a sum of a third distance between the first point of the guide jig and the second surface and a fourth distance between the first surface and the second surface.

According to an embodiment, the battery cell may include an electrode assembly, a pouch including an electrode accommodating portion accommodating the electrode assembly and a sealing portion surrounding at least a portion of the electrode accommodating portion, and an electrode tab connected to the electrode assembly, at least a portion of which is exposed outside the pouch. The attachment unit may be configured to attach the flame spread prevention sheet to the electrode accommodating portion.

According to an embodiment, the processor may be configured to inspect the attachment position of the flame spread prevention sheet, based on a distance between the sealing portion and the guide jig.

According to an embodiment, the processor may be configured to inspect the attachment position of the flame spread prevention sheet, based on a distance between the electrode tab and the guide jig.

According to an embodiment, the alignment unit may include a support block configured to support the electrode tab.

According to an embodiment, the sensor module may include a vision camera.

According to an embodiment, the sensor module may be configured to sense the position of the battery cell. The processor may be configured to adjust the attachment position of the flame spread prevention sheet, based on the position of the battery cell sensed by the sensor module.

A cell assembly manufacturing method of the disclosure of this patent document may include an alignment operation of aligning a position of a battery cell using a guide jig; an attachment operation of attaching a flame spread prevention sheet to the battery cell; a sensing operation of sensing a position of the guide jig and a position of the flame spread prevention sheet; and an inspection operation of inspecting an attachment position of the flame spread prevention sheet, based on the position of the guide jig and the position of the flame spread prevention sheet.

According to an embodiment, the inspection operation may be configured to inspect the attachment position of the flame spread prevention sheet, based on a difference between a first distance between a first point of the guide jig and a second point of the battery cell and a second distance between the first point and an edge of the flame spread prevention sheet.

According to an embodiment, the flame spread prevention sheet may include a first surface and a second surface protruding from a portion of the first surface. The inspection operation may be configured to inspect the attachment position of the flame spread prevention sheet, based on a difference between a first distance and a sum of a third distance and a fourth distance, wherein the first distance is between a first point of the guide jig and a second point of the battery cell, the third distance is between the first point of the guide jig and the second surface of the flame spread prevention sheet, and the fourth distance is between the first surface and the second surface.

According to an embodiment, the sensing operation may be configured to further sense the position of the battery cell. The attachment operation may be configured to adjust the position of the flame spread prevention sheet attached to the battery cell, based on the sensed position of the battery cell.

According to an embodiment, the cell assembly manufacturing method may further include an operation of discharging the battery cell to which the flame spread prevention sheet is not attached at a specified position, based on a result of inspecting the attachment position of the flame spread prevention sheet.

### BRIEF DESCRIPTION OF DRAWINGS

Certain aspects, features, and advantages of the disclosure of this patent document may be illustrated by the following detailed description with reference to the accompanying drawings.

FIG. 1 is a perspective view of a battery cell according to an embodiment.

FIG. 2 is an exploded perspective view of a cell assembly according to an embodiment.

FIGS. 3A and 3B are views illustrating a process for aligning a battery cell according to an embodiment.

FIGS. 4A and 4B are views illustrating a process of attaching a flame spread prevention sheet according to an embodiment.

FIGS. 5A and 5B are views illustrating a process for inspecting an attachment position of a flame spread prevention sheet according to an embodiment.

FIG. 6 is a flowchart of a cell assembly manufacturing method according to an embodiment.

FIGS. 7 and 8 are flowcharts of a process for inspecting an attachment position of a flame spread prevention sheet according to an embodiment.

### DETAILED DESCRIPTION

Features of the disclosure of this patent document disclosed in this patent document are described by example embodiments with reference to the accompanying drawings.

Hereinafter, the disclosure of this patent document will be described in detail with reference to the attached drawings. However, this is merely illustrative and the disclosure of this patent document is not limited to the specific embodiments described by way of example.

Terms or words used in the specification and claims described below may not be to be construed as limited to their ordinary or dictionary meanings. The inventor will interpret the meaning and concept consistent with the technical idea of the disclosure of this patent document based on the principle that the concept of the term is appropriately defined in order to explain the disclosure of this patent document in the best manner.

Accordingly, the embodiments described in this specification and the configurations illustrated in the drawings may be only the most preferred embodiments of the disclosure of this patent document, and do not represent the entire technical idea of the disclosure of this patent document, and it will be appreciated that there are various equivalents and variations may be substituted therefor at the time of filing the disclosure of this patent document.

Detailed descriptions of well-known functions and configurations that may obscure the gist of the disclosure of this patent document may be omitted. In the attached drawings, some components may be exaggerated, omitted, or schematically illustrated, and a size of each of the components does not entirely reflect an actual size thereof.

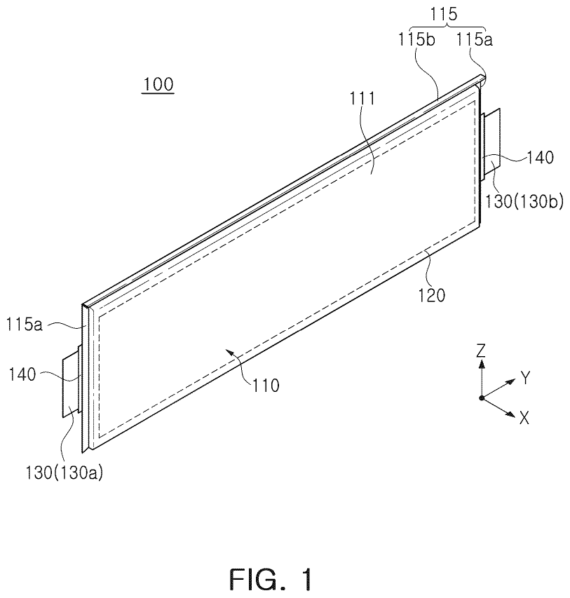

FIG. 1 is a perspective view of a battery cell according to an embodiment.

Referring to FIG. 1, a battery cell 100 may include a pouch 110, an electrode assembly 120, and an electrode tab 130. The battery cell 100 may be a secondary battery. For example, the battery cell 100 may be a lithium ion battery, but the disclosure of this patent document is not limited thereto. For example, the battery cell 100 may be a nickel-cadmium battery, a nickel-metal hydride battery, or a nickel-hydrogen battery, capable of being charged and discharged.

The pouch 110 may form at least a portion of an exterior of the battery cell 100. The pouch 110 may include an electrode accommodating portion 111 accommodating the electrode assembly 120, and a sealing portion 115 sealing at least a portion of a circumference of the electrode accommodating portion 111. The electrode accommodating portion 111 may provide a space accommodating the electrode assembly 120 and an electrolyte solution.

The sealing portion 115 may be formed by joining at least a portion of a circumference of the pouch 110. The sealing portion 115 may be formed in a flange shape extending outward from the electrode accommodating portion 111 formed in a container shape, and may be disposed along at least a portion of an external boundary of the electrode accommodating portion 111. In an embodiment, the sealing portion 115 may include a first sealing portion 115a in which the electrode tab 130 is located, and a second sealing portion 115b in which the electrode tab 130 is not located. A portion of the electrode tab 130 may be drawn out or exposed outside of the pouch 110. In a position in which the electrode tab 130 is drawn out, to increase a sealing degree of the first sealing portion 115a and at the same time ensure an electrical insulation state, the electrode tab 130 may be covered by an insulating film 140. The insulating film 140 may be formed of a film material having a thickness, smaller than a thickness of the electrode tab 130, and may be attached to both surfaces of the electrode tab 130.

In an embodiment, the electrode tabs 130 may be arranged on both sides of the battery cell 100 in a longitudinal direction (Y-axis direction) to face in opposite directions. For example, the electrode tab 130 may include a first electrode tab 130a (e.g., positive electrode tab) of a first polarity (e.g., positive polarity) facing one side of the battery cell 100 in the longitudinal direction, and a second electrode tab 130b (e.g., negative electrode tab) of a second polarity (e.g., negative polarity) facing the other side of the battery cell 100 in the longitudinal direction. In the embodiment illustrated in FIG. 1, the sealing portion 115 may include two first sealing portions 115a on which the electrode tab 130 is disposed and one second sealing portion 115b on which the electrode tab 130 is not disposed. In an embodiment, the electrode tab 130 may be referred to as an electrode lead.

A direction in which the electrode tab 130 is located may be selectively designed. In an embodiment (e.g., FIG. 1), the electrode tab 130 may include the first electrode tab 130a a facing in a first direction, and the second electrode tab 130b located in a direction (e.g., second direction), opposite to the first electrode tab 130a, based on the electrode assembly 120. In FIG. 1, the electrode tabs 130 are illustrated to face opposite directions on both sides of the battery cell 100 in the longitudinal direction (e.g., first direction (Y-axis direction)), but structures of the electrode tabs 130 are not limited thereto. For example, the two electrode tabs 130 may be arranged substantially in parallel in the longitudinal direction (e.g., Y-axis direction) of the battery cell 100.

In an embodiment of the disclosure of this patent document, at least a portion of the sealing portions 115 may be formed to be folded at least once. At least a portion of the sealing portion 115 may be folded to improve bonding reliability of the sealing portion 115 and minimize an area of the sealing portion 115. Among the sealing portions 115 according to an embodiment, the second sealing portion 115b on which the electrode tab 130 is not disposed may be folded twice and then fixed by an adhesive member (not illustrated). An angle at which the second sealing portion 115b is bent or the number of times which the second sealing portion 115b is bent may be changed. For example, in an embodiment (not illustrated), the second sealing portion 115b may be folded by 90° with respect to the first sealing portion 115a. The pouch 110 is not limited to a structure in which the sealing portion 115 is formed on three sides by folding a single sheet of exterior material, as illustrated in FIG. 1.

Those skilled in the art will understand that the electrode assembly 120 may be manufactured using a variety of methods. According to example embodiments, an electrode assembly may be formed by repeatedly arranging a positive electrode, a negative electrode, and a separator. In some embodiments, the electrode assembly may have a winding type, a stacking type, a zigzag folding type, or a stack-folding type.

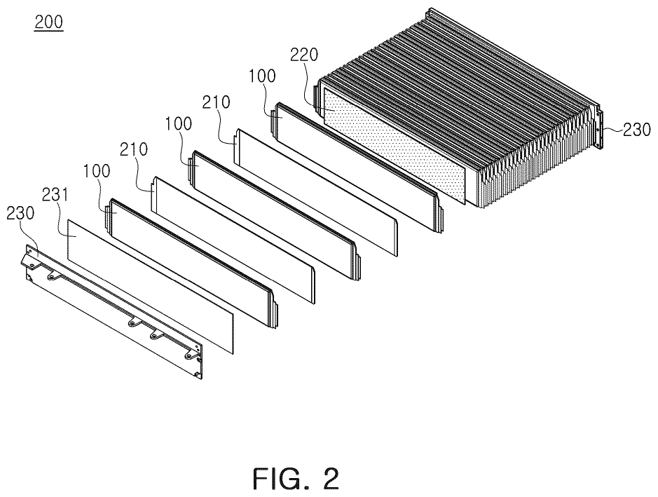

In the disclosure of this patent document, a structure in which the battery cell 100 is a pouch-type battery cell including the pouch 110 is illustrated, but is illustrative. For example, in an embodiment not illustrated, the battery cell 100 may be a prismatic battery cell. FIG. 2 is an exploded perspective view of a cell assembly according to an embodiment.

Referring to FIG. 2, a cell assembly 200 may include a plurality of battery cells 100. A description of the battery cell 100 in FIG. 1 may be applied to a battery cell 100 in FIG. 2.

According to an embodiment, the cell assembly 200 may include a flame spread prevention sheet 210 disposed between at least a portion of the plurality of battery cells 100. The flame spread prevention sheet 210 may reduce heat transfer between battery cells 100. In an embodiment, the flame spread prevention sheet 210 may include a mica sheet and/or a thermal pad. The flame spread prevention sheet 210 may be referred to as a thermal barrier.

According to an embodiment, the cell assembly 200 may include an adhesive member 220. The adhesive member 220 may be disposed between the plurality of battery cells 100 and/or between the battery cells 100 and the flame spread prevention sheet 210. The adhesive member 220 may fix positions of the plurality of battery cells 100. The adhesive member 220 may be an adhesive tape or an adhesive (e.g., hot melt).

According to an embodiment, the cell assembly 200 may include a side plate 230. The side plate 230 may be connected to the battery cells 100 located in both end portions of the cell assembly 200. For example, the side plate 230 may be attached to the battery cell 100 using an adhesive tape 231.

According to an embodiment, a structure of the cell assembly 200 may be selectively designed. For example, a shape, a voltage, and/or capacity of the cell assembly 200 may be selectively changed.

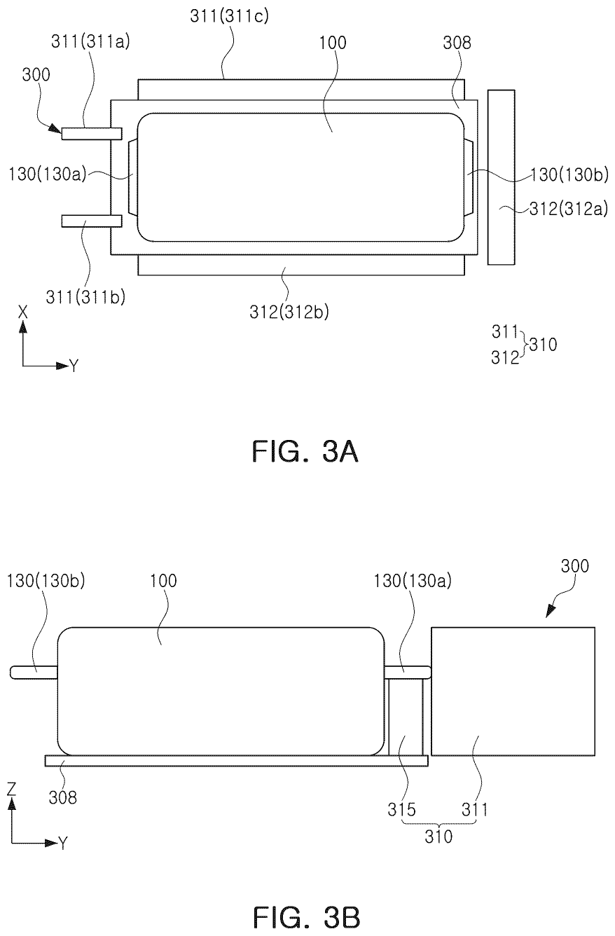

FIGS. 3A and 3B are views illustrating a process for aligning a battery cell according to an embodiment.

Referring to FIGS. 3A and 3B, a cell assembly manufacturing device 300 may include an alignment unit 310 configured to align a position of a battery cell 100. In an embodiment, the cell assembly manufacturing device 300 may be referred to as a device inspecting an attachment position of a flame spread prevention sheet.

The cell assembly manufacturing device 300 may include a transport device (not illustrated) transferring the battery cell 100. The battery cell 100 may be disposed on a stage 308 using the transport device. The transport device may include a conveyor belt and/or a gripper.

The alignment unit 310 may align the position of the battery cell 100 disposed on the stage 308. For example, the alignment unit 310 may include a guide jig 311 providing pressure or force outside the battery cell 100 to change the position of the battery cell 100. The alignment unit 310 may be connected to a drive device (e.g., motor, gear, and/or hydraulic structure), and move relative to the battery cell 100. According to an embodiment, the alignment unit 310 may adjust the position of the battery cell 100 to locate the battery cell 100 at a designated point.

The guide jig 311 may include a first guide jig 311a and a second guide jig 311b spaced apart from the first guide jig 311a. The first guide jig 311a and the second guide jig 311b may be located in different directions, based on an electrode tab 130. For example, when the guide jig 311 provides external force to the battery cell 100, at least a portion of the electrode tab 130 may be located between the first guide jig 311a and the second guide jig 311b. The second guide jig 311b may be spaced substantially parallel to the first guide jig 311a. In an embodiment, the first guide jig 311a and the second guide jig 311b may press a side surface of the battery cell 100 adjacent to the electrode tab 130 in the first direction (e.g., Y-axis direction). The position of the battery cell 100 in the first direction (Y-axis direction) may be changed by the first guide jig 311a and the second guide jig 311b.

According to an embodiment, the guide jig 311 may include a third guide jig 311c. In a direction, different from (e.g., substantially perpendicular to) the first guide jig 311a and the second guide jig 311b, the third guide jig 311c may press the battery cell 100 in the second direction (e.g., X-axis direction). The position of the battery cell 100 in the second direction (X-axis direction) may be changed by the third guide jig 311c.

The alignment unit 310 may include a support member 312. The support member 312 may reduce or prevent movement of the battery cell 100, when the guide jig 311 provides external force to the battery cell 100. The support member 312 may be located in a different direction from the guide jig 311, based on the battery cell 100. According to an embodiment, the alignment unit 310 may include a first support member 312a controlling movement of the battery cell 100 by the first guide jig 311a and the second guide jig 311b. The first guide jig 311a and the second guide jig 311b may be located to be opposite to the first support member 312a, based on the battery cell 100. For example, the first guide jig 311a and the second guide jig 311b may face a first electrode tab 130a, and the first support member 312a may face a second electrode tab 130b. According to an embodiment, the alignment unit 310 may include a second support member 312b controlling movement of the battery cell 100 by the third guide jig 311c. The third guide jig 311c may be located to be opposite to the second support member 312b, based on the battery cell 100.

According to an embodiment (e.g., FIG. 3B), the alignment unit 310 may include a support block 315. The support block 315 may support at least a portion of the electrode tab 130. For example, the support block 315 may be located below the electrode tab 130. When the position of the battery cell 100 is adjusted by the guide jig 311, the support block 315 may be located between at least a portion of the electrode tab 130 and the stage 308. Sagging or bending of the electrode tab 130 may be reduced by the support block 315.

According to an embodiment, the support block 315 may be connected to the guide jig 311. For example, the support block 315 may move relative to the battery cell 100, together with the guide jig 311. In an embodiment, the support block 315 may be located between the first guide jig 311a and the second guide jig 311b.

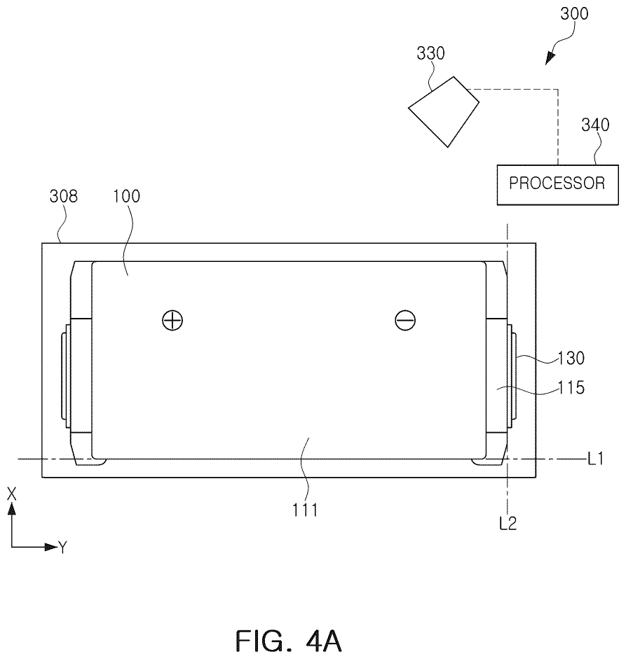

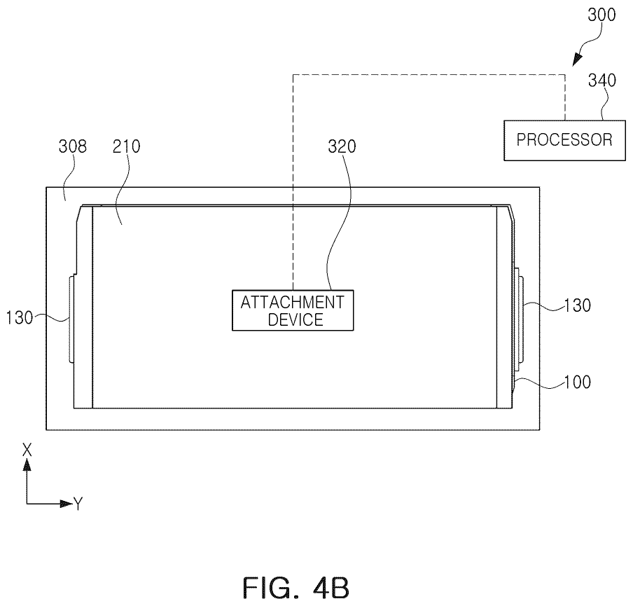

FIGS. 4A and 4B are views illustrating a process of attaching a flame spread prevention sheet according to an embodiment.

Referring to FIGS. 4A and/or 4B, a cell assembly manufacturing device 300 may attach a flame spread prevention sheet 210 to a battery cell 100. Descriptions of the battery cell 100, the flame spread prevention sheet 210, the stage 308, and the cell assembly manufacturing device 300 in FIGS. 1, 2, 3A, and/or 3B may be applied to the battery cell 100, the flame spread prevention sheet 210, a stage 308, and the cell assembly manufacturing device 300 in FIGS. 4A and/or 4B.

According to an embodiment, the cell assembly manufacturing device 300 may include an attachment unit 320 attaching the flame spread prevention sheet 210 to the battery cell 100. The attachment unit 320 may include a gripper or an adsorption pad moving the flame spread prevention sheet 210 and/or an adhesive member 220. The flame spread prevention sheet 210 may be attached to the battery cell 100 by the attachment unit 320. The flame spread prevention sheet 210 may cover at least a portion of an electrode accommodating portion 111 and at least a portion of a sealing portion 115 in the battery cell 100. For example, the attachment unit 320 may attach the flame spread prevention sheet 210 to the electrode accommodating portion 111.

The cell assembly manufacturing device 300 may include a sensor module 330 sensing a position of the battery cell 100. For example, the sensor module 330 may sense the position of the battery cell 100 disposed on the stage 308. In an embodiment, the sensor module 330 may sense a first line L1 and a second line L2, corresponding to positions of a surface of the battery cell 100 (e.g., electrode accommodating portion 111 and/or the sealing portion 115). In an embodiment, the sensor module 330 may be a vision camera. This is illustrative, and a type of the sensor module 330 is not limited as long as it is configured to sense the position of the battery cell 100.

According to an embodiment, the cell assembly manufacturing device 300 may include a processor 340. The processor 340 may adjust an attachment position of the flame spread prevention sheet 210, based on the position of the battery cell 100 sensed by the sensor module 330. For example, the processor 340 may obtain position information of the first line L1 and the second line L2, sensed by the sensor module 330. The processor 340 may adjust the position of the attachment unit 320 for moving the flame spread prevention sheet 210, based on the position information of the first line L1 and the second line L2, sensed by the sensor module 330. The processor 340 may be electrically connected to the attachment unit 320 and the sensor module 330.

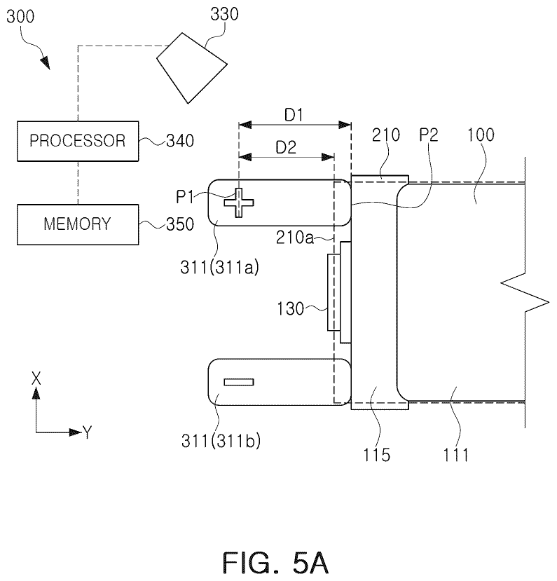

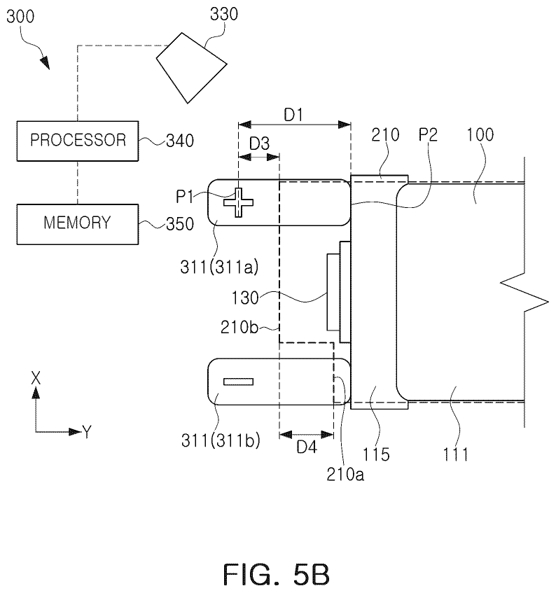

FIGS. 5A and 5B are views illustrating a process for inspecting an attachment position of a flame spread prevention sheet according to an embodiment.

Referring to FIGS. 5A and 5B, a cell assembly manufacturing device 300 may inspect an attachment position of a flame spread prevention sheet 210 attached to a battery cell 100 aligned using a guide jig 311.

Descriptions of the battery cell 100, the flame spread prevention sheet 210, the stage 308, the cell assembly manufacturing device 300, the guide jig 311, the sensor module 330, and the processor 340 in FIGS. 1, 2, 3A, 3B, 4A, and/or 4B may be applied to may be described in detail in the battery cell 100, the flame spread prevention sheet 210, a stage 308, the cell assembly manufacturing device 300, the guide jig 311, a sensor module 330, and a processor 340 in FIGS. 5A and/or 5B.

The sensor module 330 may sense the guide jig 311. For example, the sensor module 330 may sense a position of a first point P1 of the guide jig 311. In an embodiment, the first point P1 may be a designated mark or a designated shape formed on the guide jig 311. In another embodiment, the first point P1 may be a point of an end portion or an edge of the guide jig 311.

The sensor module 330 may sense the battery cell 100. For example, the sensor module 330 may sense a position of a second point P2 of the battery cell 100. In an embodiment, the second point P2 may be an edge of the battery cell 100. For example, the second point P2 may be a surface of a portion of the battery cell 100 (e.g., sealing portion 115) contacting the guide jig 311. The processor 340 may inspect the attachment position of the flame spread prevention sheet 210, based on a distance D1 between a sealing portion 115 and the guide jig 311.

At least a portion of an end portion of the flame spread prevention sheet 210 may have a protruding shape. For example, the flame spread prevention sheet 210 may include a first surface 210a, and a second surface 210b protruding from a portion of the first surface 210a. At least a portion of the first surface 210a may be located substantially parallel to a surface of an electrode tab 130. The second surface 210b may protrude with respect to the first surface 210a in the first direction (Y-axis direction) toward which the electrode tab 130 faces. For example, when the guide jig 311 is in contact with the battery cell 100, the second surface 210b may be closer to the first point P1 of the guide jig 311 than the first surface 210a. According to an embodiment, one end portion of the flame spread prevention sheet 210 may include the first surface 210a and the second surface 210b, and the other end portion of the flame spread prevention sheet 210 may include the first surface 210a, but may not include the second surface 210b.

The sensor module 330 may sense the flame spread prevention sheet 210. For example, the sensor module 330 may sense a position of a surface or edge (e.g., first surface 210a and/or second surface 210b) of the flame spread prevention sheet 210.

The cell assembly manufacturing device 300 may include a memory 350. The memory 350 may store information reflecting a size of the guide jig 311. For example, the memory 350 may store information reflecting a first distance D1 between the first point P1 of the guide jig 311 and the second point P2 of the battery cell 100. According to another embodiment, the processor 340 may determine the first distance D1, based on a position of the guide jig 311 (e.g., position of the first point P1 of the guide jig 311) and a position of the battery cell 100 (e.g., position of the second point P2), sensed in the sensor module 330.

According to an embodiment, a position of the battery cell 100, a position of the flame spread prevention sheet 210, and a position of the guide jig 311 may be sensed using the sensor module 330. The attachment position of the flame spread prevention sheet 210 may be inspected, based on the position of the battery cell 100, the position of the flame spread prevention sheet 210, and the position of the guide jig 311, sensed by the sensor module 330.

According to an embodiment (e.g., FIG. 5A), the processor 340 may determine a second distance D2, based on a position of the guide jig 311 and a position of the flame spread prevention sheet 210, sensed by the sensor module 330. For example, the second distance D2 may be a distance between the first point P1 of the guide jig 311 and the first surface 210a of the flame spread prevention sheet 210. The processor 340 may inspect the attachment position of the flame spread prevention sheet 210, based on the first distance D1 and the second distance D2. For example, when a magnitude of a difference between the first distance D1 and the second distance D2 is within a specified value, the processor 340 may determine that the flame spread prevention sheet 210 is attached in a correct position.

According to an embodiment (e.g., FIG. 5B), the processor 340 may determine a third distance D3 and a fourth distance D4, based on a position of the guide jig 311 and/or a position of the flame spread prevention sheet 210, sensed by the sensor module 330. For example, the third distance D3 may be a distance between the first point P1 of the guide jig 311 and the second surface 210b of the flame spread prevention sheet 210. The fourth distance D4 may be a distance between the first surface 210a and the second surface 210b of the flame spread prevention sheet 210. The processor 340 may inspect the attachment position of the flame spread prevention sheet 210, based on the first distance D1, the third distance D3, and the fourth distance D4. For example, when a magnitude of a difference between a sum of the third distance D3 and the fourth distance D4 and the first distance D1 is within a specified value, the processor 340 may determine that the flame spread prevention sheet 210 is attached in a correct position. As another example, the processor 340 may determine whether the flame spread prevention sheet 210 is attached at a specified angle, based on a ratio or difference between the third distance D3 and the fourth distance D4.

The attachment position of the flame spread prevention sheet 210 may be inspected using the processor 340, in a position that the attachment position of the flame spread prevention sheet 210 may not be visually recognized by a worker or user. Therefore, heat propagation between battery cells 100 in the cell assembly 200 may be delayed or reduced.

In FIGS. 5A and 5B, a configuration in which the attachment position of the flame spread prevention sheet 210 in the first direction (Y-axis direction or horizontal direction) is inspected using a first guide jig 311a and a second guide jig 311b has been illustrated. A method of inspecting the attachment position of the flame spread prevention sheet 210 is not limited thereto. For example, descriptions of the first guide jig 311a and the second guide jig 311b may be applied to a third guide jig (e.g., third guide jig 311c in FIG. 3A). The processor 340 may inspect the attachment position of the flame spread prevention sheet 210 in the second direction (X-axis direction or vertical direction) using the third guide jig (e.g., third guide jig 311c in FIG. 3A). According to an embodiment, the processor 340 may inspect a position of the flame spread prevention sheet 210 in the first direction (e.g., Y-axis direction), based on a distance (e.g., first distance D1) between the first guide jig 311a or the second guide jig 311b and the battery cell 100, and may inspect a position of the flame spread prevention sheet 210 in the second direction (e.g., X-axis direction), perpendicular to the first direction of the flame spread prevention sheet, based on a distance between the third guide jig 311c and the battery cell 100.

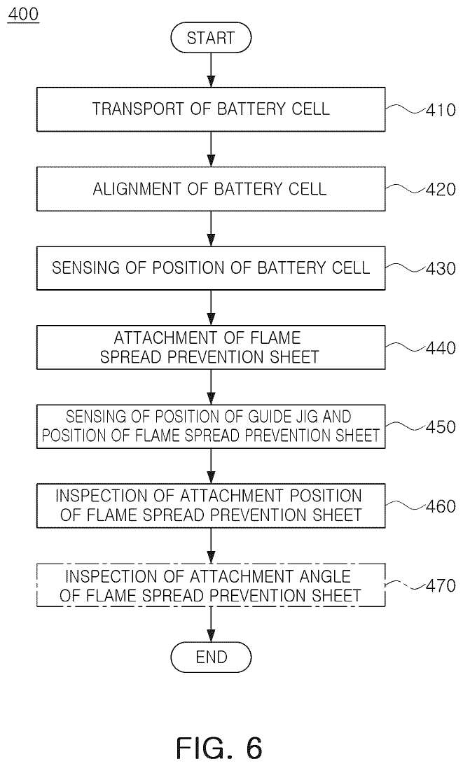

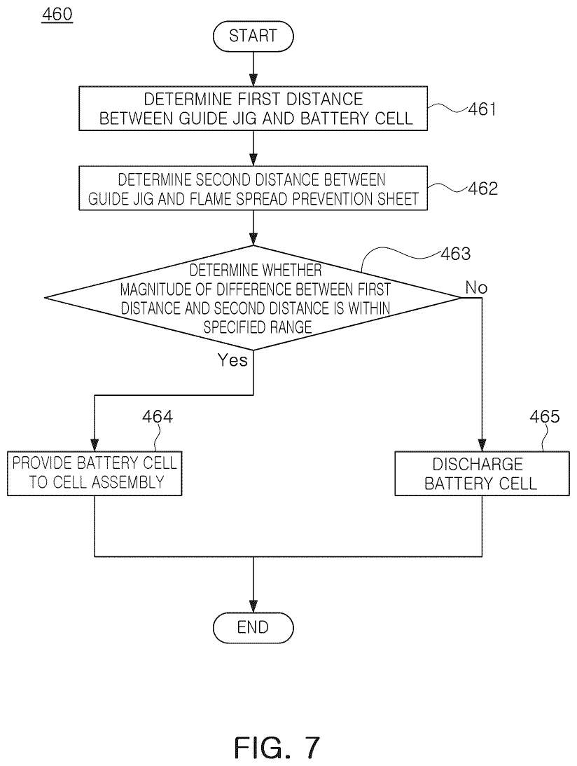

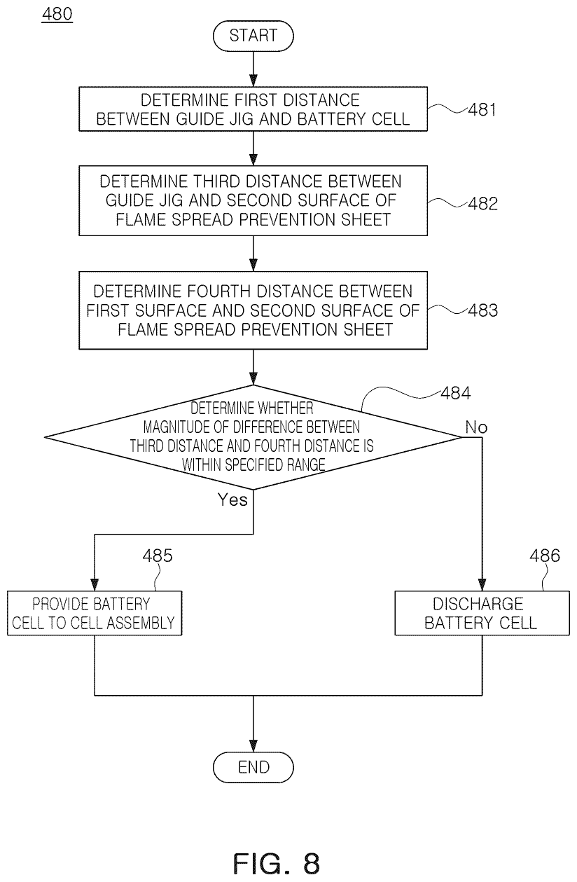

FIG. 6 is a flowchart of a cell assembly manufacturing method according to an embodiment. FIGS. 7 and 8 are flowcharts of a process for inspecting an attachment position of a flame spread prevention sheet according to an embodiment.

Referring to FIG. 6, a cell assembly manufacturing method (400) may include a transport operation (410) of a battery cell, an alignment operation (420) of the battery cell, a sensing operation (430) of a position of the battery cell, an attachment operation (440) of a flame spread prevention sheet, a sensing operation (450) of a position of the battery cell, a position of a guide jig, and a position of the flame spread prevention sheet, an inspection operation (460) of an attachment position of the flame spread prevention sheet, and/or an inspection operation (470) of an attachment angle of the flame spread prevention sheet. The cell assembly manufacturing method (400) of FIG. 6 may be a manufacturing method for manufacturing the cell assembly 200 of FIG. 2.

The transport operation (410) may be an operation of moving a battery cell (e.g., battery cell 100 in FIG. 1) to a stage (e.g., stage 308 in FIG. 4A). The transport operation (410) may be performed by a transport device (not illustrated).

The alignment operation (420) may be an operation of moving the battery cell 100 to a designated point using an alignment unit (e.g., alignment unit 310 of FIG. 3A). For example, the alignment operation (420) may be an operation of moving a position of the battery cell 100 using a guide jig (e.g., guide jig 311 in FIG. 3A) and a support member (e.g., support member 312 in FIG. 3A).

The sensing operation (430) may be an operation of sensing the position of the battery cell 100 on the stage 308 using a sensor module (e.g., sensor module 330 in FIG. 4A).

The attachment operation (440) may be an operation of attaching a flame spread prevention sheet (e.g., flame spread prevention sheet 210 of FIG. 2) to the battery cell 100 using an attachment unit (e.g., attachment unit 320 of FIG. 4B). According to an embodiment, a processor (e.g., processor 340 in FIG. 4B) may adjust a position at which the flame spread prevention sheet 210 is attached, based on the position of the battery cell 100 sensed by the sensor module 330. In other embodiments, the sensing operation (430) may be excluded. For example, the processor (e.g., processor 340 in FIG. 4B) may move the flame spread prevention sheet 210 to a specified position, using the attachment unit (e.g., attachment unit 320 in FIG. 4B).

The sensing operation (450) may be an operation of sensing a first point P1 of the guide jig 311 and an edge (e.g., first surface 210a and/or second surface 210b in FIGS. 5A and/or 5B) of the flame spread prevention sheet 210, using the sensor module 330.

The inspection operation (460) may be an operation of determining whether the flame spread prevention sheet is attached at the specified position, based on a position of the guide jig 311 and a position of the flame spread prevention sheet 210, sensed by the sensor module 330.

The inspection operation (460) may be performed in different manners, based on a shape of the flame spread prevention sheet 210.

Referring to FIG. 5A together with FIGS. 6 and 7, the inspection operation (460) may include an operation (461) of determining a first distance D1 between a guide jig 311 and a battery cell 100, an operation (462) of determining a second distance D2 between the guide jig 311 and a flame spread prevention sheet 210, and an operation (463) of determining whether a magnitude of a difference between the first distance D1 and the second distance D2 is within a specified range.

In an embodiment, the operation (461) may be an operation of determining a distance between a first point P1 of the guide jig 311 and a second point P2 of the battery cell 100, based on the first distance D1 stored in a memory 350. In another embodiment, the operation (461) may be an operation of determining the first distance D1 by a processor 340, using the distance between the first point P1 of the guide jig 311 and the second point P2 of the battery cell 100, sensed in a sensor module 330.

According to an embodiment, the operation (462) may be an operation of determining the second distance D2 by the processor 340, using a distance between the first point P1 of the guide jig 311 and a first surface 210a of the flame spread prevention sheet 210.

According to an embodiment, the operation (463) may be an operation of determining whether a magnitude of a difference between the first distance D1 and the second distance D2 is within a specified range by the processor 340. When a magnitude of a difference between the first distance D1 and the second distance D2 is within the specified range, the processor 340 may determine that the flame spread prevention sheet 210 has attached at a specified position. The processor 340 may perform an operation (464) of providing the battery cell 100 to which the flame spread prevention sheet 210 has been attached at a specified position to a cell assembly (e.g., cell assembly 200 of FIG. 2). When a magnitude of a difference between the first distance D1 and the second distance D2 exceeds a specified range, the processor 340 may determine that the flame spread prevention sheet 210 has not attached at a specified position. The processor 340 may perform an operation (465) of discharging the battery cell 100 for which the flame spread prevention sheet 210 has not been attached to the specified position. The operation (465) may be an operation of loading the battery cell 100 in which the flame spread prevention sheet 210 has not been attached to the specified position in a separate storage space.

The inspection operation (470) may be an operation of determining whether an angle at which the flame spread prevention sheet 210 has been attached to the battery cell 100 is within a specified range by the processor 340, based on information sensed by the sensor module 330. For example, the processor 340 may determine an attachment position of the flame spread prevention sheet 210 in the first direction using a first guide jig 311a or a second guide jig 311b, and may determine an attachment position of the flame spread prevention sheet 210 in the second direction using a third guide jig 311c. The processor 340 may determine the attachment angle of the flame spread prevention sheet 210 by considering the attachment positions of the flame spread prevention sheet 210 in the first direction and the attachment position in the second direction. As another example, the processor 340 may determine an angle at which the flame spread prevention sheet 210 is attached to the battery cell 100, based on a third distance D3 and a fourth distance D4. According to an embodiment, the inspection operation (470) may be excluded.

Referring to FIG. 5B together with FIG. 8, an inspection operation (480) of an attachment position of a flame spread prevention sheet may include an operation (481) of determining a first distance D1 between a guide jig 311 and a battery cell 100, an operation (482) of determining a third distance D3 between the guide jig 311 and a second surface 210b of a flame spread prevention sheet 210, an operation (483) of determining a fourth distance D4 between a first surface 210a and the second surface 210b, and an operation (484) of determining whether a magnitude of a difference between a sum of the third distance D3 and the fourth distance D4 and the first distance D1 is within a specified range. A description of the inspection operation (460) of FIG. 6 may be applied to the inspection operation (480) of FIG. 8.

A description of the operation (461) of determining the first distance D1 between the guide jig 311 and the battery cell 100 in FIG. 7 may be applied to the operation (481) of determining the first distance D1 between the guide jig 311 and the battery cell 100 in FIG. 8.

According to an embodiment, the operation (482) may be an operation of determining the third distance D3 between the first point P1 of the guide jig 311 and the second surface 210b of the flame spread prevention sheet 210 by a processor 340, sensed in a sensor module 330.

According to an embodiment, the operation (483) may be an operation of determining the fourth distance D4 between the second surface 210b and the first surface 210a of the flame spread prevention sheet 210 by the processor 340, sensed in the sensor module 330.

According to an embodiment, the operation (484) may be an operation of determining whether a magnitude of a difference between the third distance D3 and the fourth distance D4 is within a specified range by the processor 340. When a difference value of the first distance D1 with respect to a sum of the third distance D3 and the fourth distance D4 is within the specified range, the processor 340 may determine that the flame spread prevention sheet 210 has attached at a specified position. The processor 340 may perform an operation (485) of providing the battery cell 100 to which the flame spread prevention sheet 210 has been attached at a specified position to a cell assembly (e.g., cell assembly 200 of FIG. 2). When a difference value of the first distance D1 with respect to a sum of the third distance D3 and the fourth distance D4 exceeds the specified range, the processor 340 may determine that the flame spread prevention sheet 210 has not attached at a specified position. The processor 340 may perform an operation (486) of discharging the battery cell 100 for which the flame spread prevention sheet 210 has not been attached to the specified position. The operation (486) may be an operation of loading the battery cell 100 in which the flame spread prevention sheet 210 has not been attached to the specified position in a separate storage space.

The inspection operation (470) may be an operation of determining whether an angle at which the flame spread prevention sheet 210 has been attached to the battery cell 100 is within a specified range by the processor 340, based on information sensed by the sensor module 330. For example, the processor 340 may determine an attachment position of the flame spread prevention sheet 210 in the first direction using a first guide jig 311a or a second guide jig 311b, and may determine an attachment position of the flame spread prevention sheet 210 in the second direction using a third guide jig 311c. The processor 340 may determine the attachment angle of the flame spread prevention sheet 210 by considering the attachment positions of the flame spread prevention sheet 210 in the first direction and the attachment position in the second direction. As another example, the processor 340 may determine an angle at which the flame spread prevention sheet 210 is attached to the battery cell 100, based on a third distance D3 and a fourth distance D4. According to an embodiment, the inspection operation (470) may be excluded.

The contents described above may be merely an example of applying the principles of the disclosure of this patent document, and other configurations may be further included without departing from the scope of the disclosure of this patent document.

According to an embodiment of the disclosure of this patent document, attachment accuracy of a flame spread prevention sheet with regard to a battery cell may be improved.

According to an embodiment of the disclosure of this patent document, ease and accuracy of inspecting an attachment position of a flame spread prevention sheet may be improved.

Only specific examples of implementations of certain embodiments may be described. Variations, improvements and enhancements of the disclosed embodiments and other embodiments may be made based on the disclosure of this patent document.

What is claimed is:

1. A cell assembly manufacturing device comprising:
an alignment unit including a guide jig configured to align a position of a battery cell;
an attachment unit configured to attach a flame spread prevention sheet to the battery cell;
a sensor module configured to sense a position of the guide jig and a position of the flame spread prevention sheet; and
a processor configured to inspect an attachment position of the flame spread prevention sheet, based on the position of the guide jig and the position of the flame spread prevention sheet sensed by the sensor module.

2. The cell assembly manufacturing device of claim 1, further comprising a memory configured to store information reflecting a first distance between a first point of the guide jig and a second point of the battery cell,
wherein the processor is configured to determine a second distance between the first point and an edge of the flame spread prevention sheet, based on information sensed by the sensor module, and
the processor is configured to inspect the attachment position of the flame spread prevention sheet, based on a difference between the first distance and the second distance.

3. The cell assembly manufacturing device of claim 2, wherein the flame spread prevention sheet comprises a first surface and a second surface protruding from a portion of the first surface, and
the processor is configured to inspect the attachment position of the flame spread prevention sheet, based on a difference between the first distance and a sum of a third distance between the first point of the guide jig and the second surface and a fourth distance between the first surface and the second surface.

4. The cell assembly manufacturing device of claim 1, wherein the battery cell comprises an electrode assembly, a pouch including an electrode accommodating portion accommodating the electrode assembly and a sealing portion surrounding at least a portion of the electrode accommodating portion, and an electrode tab connected to the electrode assembly, and at least a portion of which is exposed outside the pouch, and
the attachment unit is configured to attach the flame spread prevention sheet to the electrode accommodating portion.

5. The cell assembly manufacturing device of claim 4, wherein the processor is configured to inspect the attachment position of the flame spread prevention sheet, based on a distance between the sealing portion and the guide jig.

6. The cell assembly manufacturing device of claim 4, wherein the guide jig comprises a first guide jig and a second guide jig spaced apart from the first guide jig,
wherein the first guide jig and the second guide jig are configured to be located in different directions with respect to the electrode tab.

7. The cell assembly manufacturing device of claim 6, wherein the guide jig further comprises a third guide jig, perpendicular to the first guide jig and the second guide jig, and
the processor is configured to:
inspect a position of the flame spread prevention sheet in a first direction, based on a distance between the first guide jig or the second guide jig and the battery cell, and
inspect a position of the flame spread prevention sheet in a second direction, perpendicular to the first direction, based on a distance between the third guide jig and the battery cell.

8. The cell assembly manufacturing device of claim 4, wherein the alignment unit comprises a support block configured to support the electrode tab.

9. The cell assembly manufacturing device of claim 1, wherein the sensor module comprises a vision camera.

10. The cell assembly manufacturing device of claim 1, wherein the sensor module is configured to sense the position of the battery cell, and
the processor is configured to adjust the attachment position of the flame spread prevention sheet, based on the position of the battery cell sensed by the sensor module.

11. A cell assembly manufacturing method comprising:
an alignment operation of aligning a position of a battery cell using a guide jig;
an attachment operation of attaching a flame spread prevention sheet to the battery cell;
a sensing operation of sensing a position of the guide jig and a position of the flame spread prevention sheet; and
an inspection operation of inspecting an attachment position of the flame spread prevention sheet, based on the position of the guide jig and the position of the flame spread prevention sheet.

12. The cell assembly manufacturing method of claim 11, wherein the inspection operation is configured to inspect the attachment position of the flame spread prevention sheet, based on a difference between a first distance between a first point of the guide jig and a second point of the battery cell and a second distance between the first point and an edge of the flame spread prevention sheet.

13. The cell assembly manufacturing method of claim 11, wherein the flame spread prevention sheet comprises a first surface and a second surface protruding from a portion of the first surface, and
the inspection operation is configured to inspect the attachment position of the flame spread prevention sheet, based on a difference between a first distance and a sum of a third distance and a fourth distance, wherein the first distance is between a first point of the guide jig and a second point of the battery cell, the third distance is between the first point of the guide jig and the second surface of the flame spread prevention sheet, and the fourth distance is between the first surface and the second surface.

14. The cell assembly manufacturing method of claim 11, wherein the sensing operation is configured to further sense the position of the battery cell, and
the attachment operation is configured to adjust the position of the flame spread prevention sheet attached to the battery cell, based on the sensed position of the battery cell.

15. The cell assembly manufacturing method of claim 11, further comprising an operation of discharging the battery cell to which the flame spread prevention sheet is not attached at a specified position, based on a result of inspecting the attachment position of the flame spread prevention sheet.
